(19) United States
(12) Patent Application Publication
(10) Pub. No.: US 2017/0351865 A1
(43) Pub. Date: Dec. 7, 2017

(54) COMPUTING DEVICE TO GENERATE A SECURITY INDICATOR

(71) Applicant: QUALCOMM Incorporated, San Diego, CA (US)

(72) Inventor: Or ELNEKAVEH, Kfar Vitkin (IL)

(21) Appl. No.: 15/174,823

(22) Filed: Jun. 6, 2016

(51) Int. Cl. G06F 21/62; G06F 3/0484; G06T 11/00; G06Q 40/02; G06F 21/16

(52) U.S. Cl. CPC G06F 21/6209; G06Q 40/02; G06F 21/16; G06T 11/00; G06F 3/04842; G06F 2221/0737; G06T 2207/20212

(57) ABSTRACT

Aspects may relate to a computing device that comprises a processor operable in a secure mode and a memory. The processor may be configured to: obtain a first layer of graphics that includes image elements; obtain a second layer of graphics that includes image elements; randomly select an image element from the first layer of graphics; randomly select an image element from the second layer of graphics; and compose the selected image elements from the first and second layer of graphics to create a composed random image. Further, the processor may command the memory to store the composed random image.

### BACKGROUND

### Field

The present invention relates to a computing device that generates a security indicator.

### Relevant Background

Security indicators may be visual indicators that are visible on a computing device that are used to allow a user to visually tell whether the computing device is currently operated by a trusted application or not. Many different types of security indicators are currently used to achieve this function, but many presently utilized security indicators have particular types of deficiencies.

As an example, one type of security indicator, which may be utilized, may be a discrete hardware component, such as, an LED, which can only be operated by a trusted application. However, the number of hardware components utilized for this purpose significantly increases the costs of the computing device, such that, it may not be considered cost efficient.

Existing displays of the computing device may be used to display a security indicator. However, a problem exists in that the device's screen is a resource being shared between trusted and untrusted applications. As such, an untrusted application may simply emulate the visuals of a trusted application, opening the door to different kinds of attacks.

One way to mitigate the problem of impersonating a visual indicator may be by establishing a visual ‘something you know’ secret between the trusted application and the user. Such visual indicator is known only to the user and the trusted application.

In general, humans' visual pattern recognition is highly evolved and is very fast in recognizing/rejecting an image, making a security indicator preferable to written text.

For example, letting users pick a photograph from their own image stock may be a way to establish a good recognizable image with some level of unpredictability for some security purposes.

However, letting users pick their own images provides many problems. For example, some computing devices may not even have access to a user's images, or that such images are potentially known to an adversary. Accordingly, methods to create security indicators that are easily recognizable by the user that cannot be guessed or predicted by an attacker would be beneficial.

### SUMMARY

Aspects may relate to a computing device that comprises a processor operable in a secure mode and a memory. The processor may be configured to: obtain a first layer of graphics that includes image elements; obtain a second layer of graphics that includes image elements; randomly select an image element from the first layer of graphics; randomly select an image element from the second layer of graphics; and compose the selected image elements from the first and second layer of graphics to create a composed random image. Further, the processor may command the memory to store the composed random image.

### BRIEF DESCRIPTION OF THE DRAWINGS

FIG. 1 is a diagram of a system in which embodiments may be practiced.

FIG. 2 is a diagram of an example of various components related to image elements.

FIG. 3 is a diagram of an example of a variety of different types of applications that may be utilized.

FIG. 4 is a diagram of an example illustrating the generation of a security indicator based upon image elements.

FIG. 5 is flow diagram illustrating a process to generate a composed random image that may be used a security indicator.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, or any type of computing device or data processing apparatus.

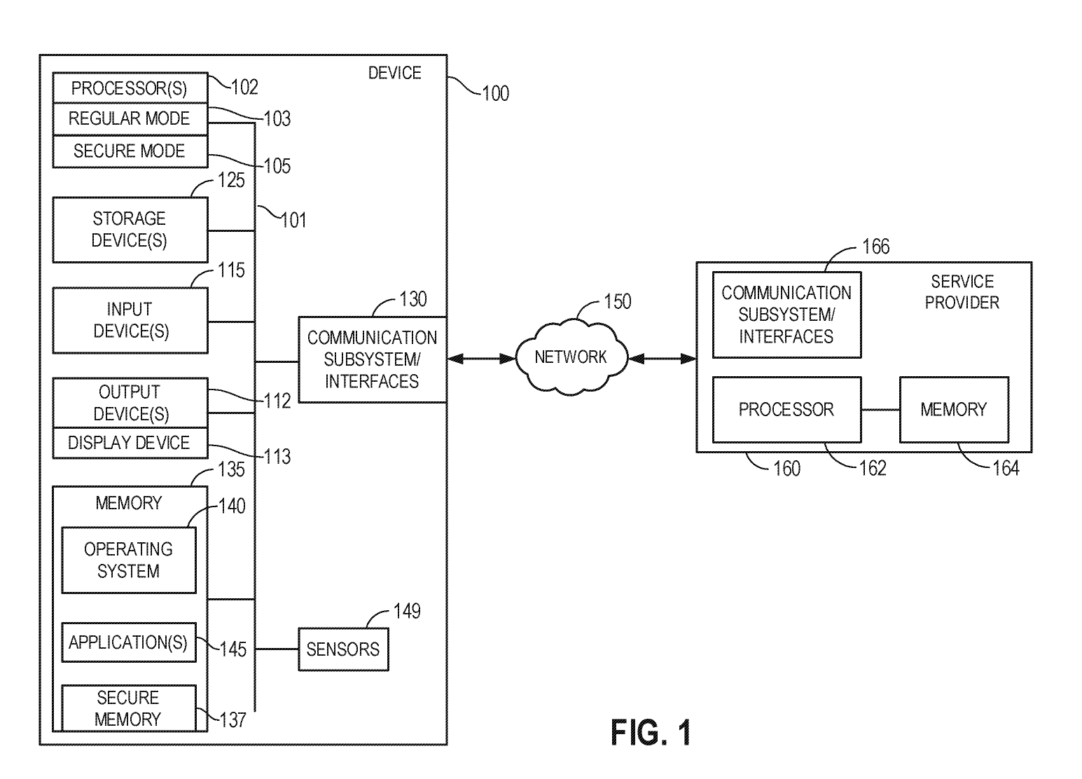

With reference to FIG. 1, an example computing device 100 may be in communication with one or more other computing devices 160 (e.g., service providers), respectively, via a network 150. For example, remote computing device 160 may be a service provider (e.g., finance, commerce, medical, government, corporate, social networking, etc.) that provides services based on data exchanges with computing device 100 through the network 150.

As an example, computing device 100 may comprise hardware elements that can be electrically coupled via a bus 101 (or may otherwise be in communication, as appropriate). The hardware elements may include one or more processors 102, including without limitation one or more general-purpose processors and/or one or more special-purpose processors (such as secure processors, cryptoprocessors, digital signal processing chips, graphics acceleration processors, and/or the like); one or more input devices 115 (e.g., keyboard, keypad, touchscreen, mouse, etc.); and one or more output devices 112—such as a display device (e.g., screen) 113, speaker, etc. Additionally, computing device 100 may include a wide variety of sensors 149. Sensors may include: a clock, an ambient light sensor (ALS), a biometric sensor (e.g., blood pressure monitor, etc.), an accelerometer, a gyroscope, a magnetometer, an orientation sensor, a fingerprint sensor, a weather sensor (e.g., temperature, wind, humidity, barometric pressure, etc.), a Global Positioning Sensor (GPS), an infrared (IR) sensor, a proximity sensor, near field communication (NFC) sensor, a microphone, a camera, or any type of sensor.

In one embodiment, processor 102 may operate in a regular mode 103 and/or a secure mode 105. In one embodiment, processor 102 may itself be a secure processor and/or operate in the secure mode 105 to create a trusted execution environment to allow for the creation of security indicators to designate trusted applications and to allow the trusted applications to operate in a trusted execution environment.

Computing device 100 may further include (and/or be in communication with) one or more non-transitory storage devices or non-transitory memories 125, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Computing device 100 may also include communication subsystems and/or interfaces 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communications subsystems and/or interfaces 130 may permit data to be exchanged with other computing devices 160 (e.g., service providers, etc.) through an appropriate network 150 (wireless and/or wired).

In some embodiments, computing device 100 may further comprise a working memory 135, which can include a RAM or ROM device, as described above. Computing device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (and/or a processor within a device); in an aspect, then, such code and/or instructions can be used to configure and/or adapt a computing device 100 to perform one or more operations in accordance with the described methods, according to embodiments described herein.

A set of these instructions and/or code may be stored on a non-transitory computer-readable storage medium, such as the storage device(s) 125 described above. In some cases, the storage medium might be incorporated within a computer system, such as computing device 100. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by computing device 100 and/or might take the form of source and/or installable code, which, upon compilation and/or installation on computing device 100 (e.g., using any of a variety of generally available compilers, installation programs, compression/decompression utilities, etc.), then takes the form of executable code.

Also, computing device 100 may include a memory, such as, a secure memory 137, to allow for the storage of security indicators to designate trusted applications and enable trusted applications to operate in a trusted execution environment. Secure memory 137 may be any type of suitable non-volatile memory often utilized for security purposes.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other computing devices such as network input/output devices may be employed.

As previously described, computing device 100 may be any type of device, computer, smartphone, tablet, cellular telephone, watch, wearable device, Internet of Things (IoT) device, or any type of computing device that can communicate with other computing devices 160 via a wired and/or wireless network 150. Further, as has been previously described, computing device 100 may be in communication via interface 130 through network 150 to a service provider 160. It should be appreciated that service provider 160 may be a computing device having at least a processor 162, a memory 164, an interface/communication subsystem 166, as well as other hardware and software components, to implement operations. For example, service provider 160 may be a particular type of service provider (e.g., finance, commerce, medical, government, corporate, social networking, etc.) that provides services based on data exchanges with computing device 100 through the network 150. It should be appreciated that computing device 100 and service provider 160 may be in communication through network 150 in a wireless, wired, or combination of wireless/wired fashion.

Embodiments may relate to a device and method to automatically create a security indicator for a user that is easily recognizable by the user to verify and attest that a trusted application is operating in a trusted execution environment. Further, the security indicator should not be able to be easily guessed or predicted by an attacker/hacker. Additionally, this implementation provides a pleasant user experience in conjunction with enhanced security.

In particular, embodiments may relate an apparatus and method to automatically generate a security indicator for a user. In one embodiment, computing device 100 may include one or more processor(s) 102 and a memory, such as, a secure memory 137. In one embodiment, as previously described, processor 102 may itself be a secure processor and/or operate in the secure mode 105 to create a trusted execution environment to allow for the creation of security indicators to designate trusted applications and to allow the trusted applications to operate in a trusted execution environment. Processor 102 will be hereafter referred to as secure processor 102.

In one embodiment, secure processor 102 may be configured to: obtain a first layer of graphics that includes image elements; obtain a second layer of graphics that includes image elements; randomly select an image element from the first layer of graphics; and randomly select an image element from the second layer of graphics. Further, secure processor 102 may be configured to compose the selected image elements from the first and second layer of graphics to create a composed random image that serves as the security indicator. The secure processor 102 may command that the composed random image be stored to secure memory 137. In one embodiment, secure processor 102 may be configured to command the display device 113 to display the composed random image as the security indicator to a user when an application 145 on the computing device 100 is selected by the user in a secure display environment.

In one embodiment, when a user selects an application 145 on the computing device 100, the secure processor 102 may command the display device 113 to display the security indicator to the user in a secure display environment. In this way, the security indicator provides an authentication image for the user to ensure that the application 145 is a trusted application and operating in a trusted execution environment. On the other hand, if the security indicator displayed is not the security indicator that the user is familiar with, then the user can notice by the incorrect security indicator that it is not the expected trusted application in a trusted execution environment and may be compromised such that the user is notified to not trust the application. Aspects of the secure display environment will be hereafter described in more detail. Also, it should be appreciated that the secure display environment is not required in the application selection phase, although it may be utilized.

The secure display environment may be controlled by the use of secure processor 102 in order to prevent malicious software that may run alongside and concurrently to trusted applications from reading, writing, modifying, blocking, or tampering with the content of the screen. For example, by utilizing the secure display environment, an attacker may be prevented from causing a user to confirm a displayed $10.00 transaction that is actually a $10,000.00 transaction. Further, by utilizing the secure display environment under the control of the secure processor 102, the security indicator may be displayed on the display device 113 without the risk of malicious software obtaining it (e.g., via a screenshot). The secure display environment may share the same physical screen on the display device 113 with other applications running in secure and non-secure modes. Utilizing the secure display environment is not required for implementation of embodiments described herein, but adds an extra layer of protection.

In one particular embodiment, an application 145 may be enrolled by the user, and when this occurs, secure processor 102 may be configured to: create the composed random image; store the composed random image in secure memory 137; and command the display of the composed random image as the security indicator on the display device 113. This enrollment process may occur in a secure display environment, as previously described. In this way, when the application 145 is used, in the future, the security indicator is displayed on the display device 113 to the user as an authentication image for the user to ensure that the application 145 is a trusted application and operating in a trusted execution environment. If the security indicator displayed is not the security indicator created for the application 145 upon enrollment, then the user can notice by the incorrect security indicator that it is not a trusted application in a trusted execution environment and may be compromised such that the user is notified to not trust the application.

Also, it should be appreciated that both the selection and enrollment of applications in conjunction with the security indicator may occur with the use of secure input from the user. Secure input may be controlled by secure processor 102. All of the different types of user input (e.g., touch events, fingerprints, voice input, audio input, motion input, biometric input, buttons, external devices, etc.) may be directed to secure processor 102 and controlled by secure processor 102. Secure input prevents malicious software that may run alongside and concurrently to trusted applications from reading, writing, modifying, injecting, or denying user input. With secure input functionality, applications operating with the security indicator according to embodiments described herein may share the same physical devices with other applications running in secure and non-secure modes. Utilizing the secure input functionality is not required for implementation of embodiments described herein, but adds an extra layer of protection.

As will be hereafter described, various types of applications may be enrolled and security indicators may be developed for each one of the applications 145. Also, one type of security indicator may be used for all of the applications of the computing device 100 or for particular sets of applications of the computing device 100. These types of implementations are design characteristics that may be selectable by the computing device 100 or the user. Also, it should be appreciated that, in one embodiment, an operating system may manage processes in which: security indicators are specific to each application on a per application basis; a security indicator is specific for all applications; or a security indicator is specific for a group/type of applications. Further, as will be hereafter described, these types of applications may include: financial applications, government applications, commerce applications, corporate applications, medical applications, social networking applications, etc. that may be implemented for use in communication with a service provider 160 through a network 150. It should be appreciated that any type of application to which a security indicator may be utilized to provide proof to the user that the application is a trusted application operating in a trusted execution environment may be utilized.

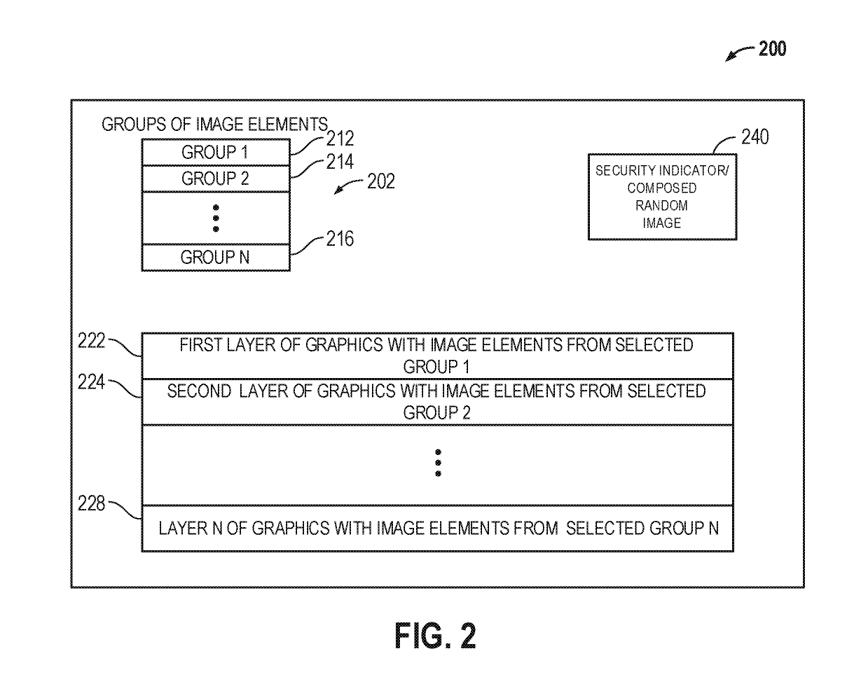

With additional reference to FIG. 2, an example 200 of various components of the process is described. In particular, a group of image elements 202 may be provided. The group of image elements may include: group 1 212; group 2 214; . . . group N 216. Therefore, a group of image elements 202 that provides groups of images including image elements that may be selectable by secure processor 102 for the creation of the composed random image for use as a security indicator 240 is provided. In one embodiment, as an example, secure processor 102 may obtain a randomly selected image from group 1 212 and may obtain a randomly selected image from group 2 214 that are composed to create a composed random image that serves as the security indicator 240. As will be described, these image elements may be any type of image, such as: trees, cars, traffic lanes, faces, stars, circles, airplanes, rockets, numbers, letters, symbols, etc. As should be apparent, any type of graphical image that may be recognizable by a user may be utilized. As will be described in more detail later, to increase the visual difference among images, secure processor 102 may apply a transformation to selected images by differing sizes, colors, shapes, orientations, etc.

Based upon the groups of image elements 202, secure processor 102 may: obtain a first layer of graphics 222 that includes image elements from the selected first group 212; obtain a second layer of graphics 224 that includes image elements from the selected second group 214. Further, secure processor 102 may: randomly select an image element from the first layer of graphics 222 and randomly select an image element from the second layer of graphics 224; and then compose the randomly selected image elements from the first and second layer of graphics 222 and 224 to create a composed random image that serves as the security indicator 240.

As should be appreciated, any number of layers of graphics (first layer 222, second layer 224, all the way to layer N 228) from any number of groups of image elements (group 1 212, group 2 214, all the way to group N 216) may be utilized to provide image elements that are randomly selected and then composed by the secure processor 102 to create a composed random image that serves as the security indicator 240. Thus, any number layers of graphics may be generated from the group of image elements 202 to create and compose a security indicator 240. Further, it should be appreciated that each layer of graphics (first layer 222, second layer 224 . . . layer N 228) may be randomly selected by the secure processor 102 from any of the groups (group 1 212, group 2 214 . . . group N 216) of image elements 202. Thus, the description of only the first and second layer of graphics 212 and 214 being used to create the security indicator 240 is merely utilized as an example. It should be appreciated that in some embodiments, multiple elements from a same single layer may be randomly selected, combined, and composed in order to create the security indicator 240 in the previously described process. Also, as will be described in more detail later, each image element of each layer of graphics selected by the secure processor 102 may include at least one of a differing structure feature, shape, color, orientation, etc., for differentiation purposes

Security considerations have become an essential element for data transfer between computing devices and distant service providers over networks. As previously described, a computing device 100 may operate in a trusted execution environment. Further, users would like to operate “trusted” applications in the trusted execution environment. Embodiments are disclosed that verify the use of a trusted application by generating and thereafter displaying a security indicator 240 that may be utilized to verify to the user that the application is a trusted application and is operating in a trusted execution environment. A multitude of examples may be provided.

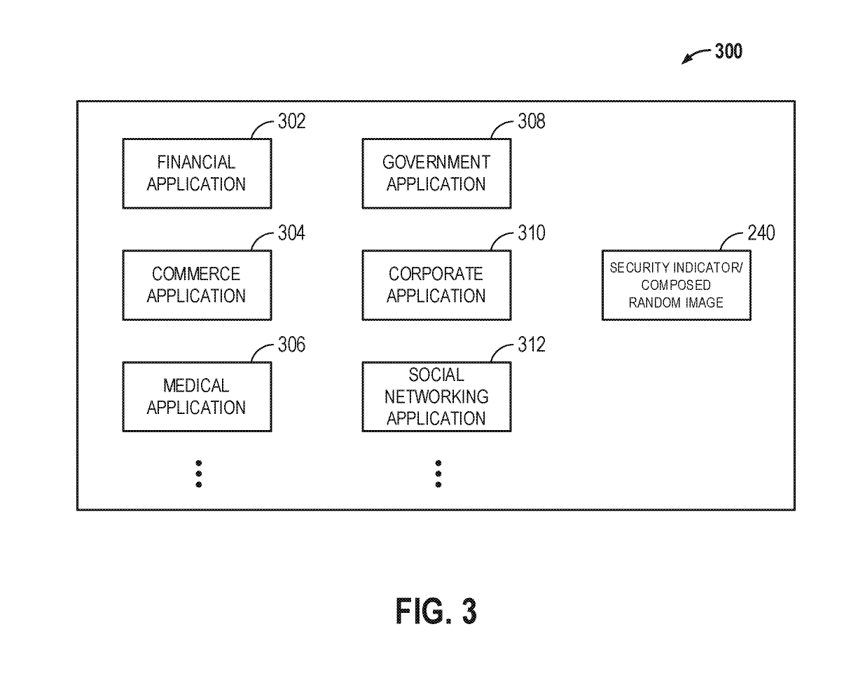

With brief additional reference to FIG. 3, a variety of different applications 300 that may be utilized with embodiments to be hereafter described are illustrated. Examples of applications 300 that may be verified as trusted include: a financial application 302; a commerce application 304; a medical application 306; a government application 308; a corporate application 310; a social networking application 312; etc. It should be appreciated that any type of application may be utilized and that a user may wish to have a security indicator 240 to verify that it is indeed a trusted application operating in a trusted execution environment.

As an example, a user may click a financial application 302 to interface with a bank service provider 160 over a network 150 to perform a financial transaction (e.g., a money transfer from savings to checking). Since the financial application 302 has already been enrolled by a user, a security indicator 240 showing a star that is colored red may have been generated and identified to the user as their security indicator 240 for the financial application and stored in secure memory 137. When a user clicks on the financial application 302 to perform a bank transaction (e.g., a money transfer from savings to checking) if the correct red-colored star pops up as security indicator 240, the user can feel confident that this is a trusted application operating in a trusted execution environment (e.g., it is not a hacker malware application) and the user can proceed with their financial transaction with the bank service provider 160 with a verification assurance. However, if the security indicator 240 is not the security indicator created for the financial application 302 from enrollment, then the user may be made aware by the incorrect security indicator that it is not a trusted application in a trusted execution environment and may be compromised and is notified to not trust the application pretending to be the financial application 302. As should be apparent, the same procedure to generate security indicators 240 for other applications (e.g., a commerce application 304; a medical application 306; a government application 308; a corporate application 310; a social networking application 312; etc.) that are displayed to the user to provide verification that the application is operating as a trusted application in a trusted execution environment operates in a similar manner It should be appreciated that the user enrollment and selection of the applications and the display of the security indicators 240 for verification may occur in the secure display environment and/or with secure input functionality, as previously described. Further, it should be apparent that these are just example types of applications and that this methodology may work with any type of application. Various other examples will be hereafter described.

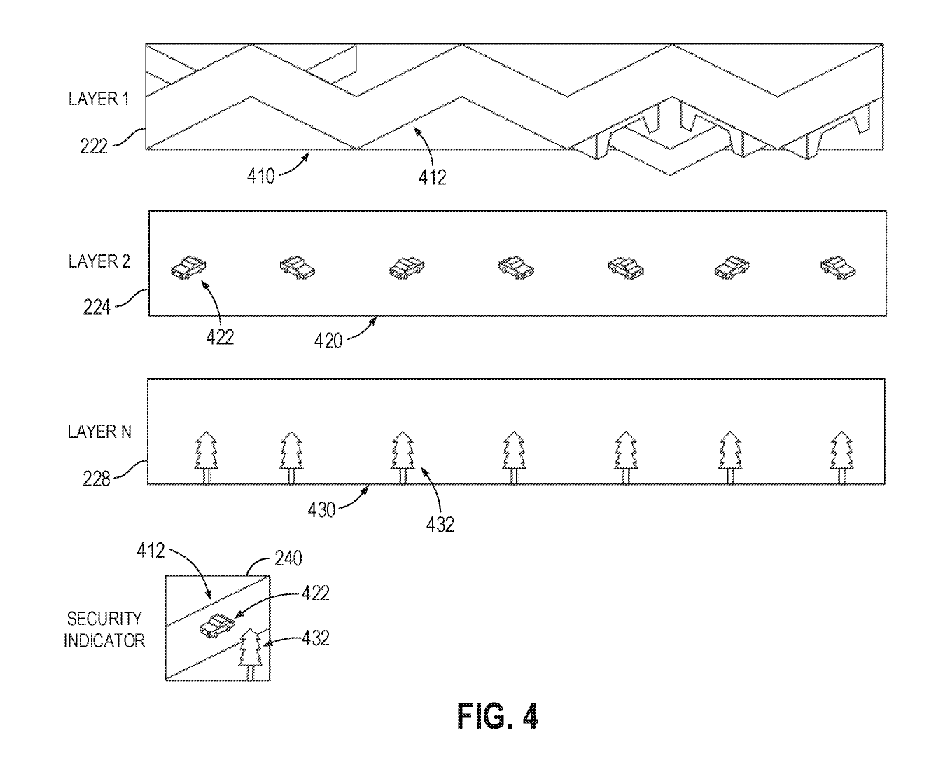

With additional reference to FIG. 4, a particular example will now be provided to illustrate the generation of a security indicator 240. As an example, secure processor 102 of computing device 100 may obtain a first layer 222 of graphics that includes a graphical strip of image elements 410 (e.g., from group 1 212 of group image elements). In this particular example, the image elements 412 are street lanes. Further, continuing with the example, the secure processor may obtain a second layer 224 of graphics that includes a graphical strip of image elements 420 (e.g., from group 2 214 of group image elements). In this example, the image elements 422 are cars. As has been described any number of layers of graphics may be selected. Continuing with this example, the secure processor may obtain a third layer 228 of graphics that includes a graphical strip of image elements 430 (e.g., from group N 216 of group image elements). In this example, the image elements 432 are trees.

Continuing with this example, secure processor 102 may randomly select an image element 412, 422, 432 from each of these layers (layer 1 222, layer 2 224, layer 3 228). Based upon these randomly selected image elements 412, 422, 432 from the first, second, and third layers, these random selected image elements are overlaid to create the composed random image that services as security indicator 240. In this example, street image element 412 from the streets of layer 1 222 was selected; car image element 422 from cars of layer 2 224 was selected; and tree image element 432 from trees of layer 3 228 was selected. These particular street, car, and tree image elements are combined to create the security indicator 240. It should be noted that each image element of each layer of graphics that are selectable by the secure processor may include differing structure features, shapes, colors, orientation, etc. It should further be appreciated that this is purely one example of image elements that may be used. It should be appreciated that any type of graphical image element, e.g., faces, stars, trees, streets, automobiles, airplanes, furniture, flowers, utensils, text, symbols (i.e., any type of graphical image) having different types of structural features, shapes, colors, orientation, etc., may be utilized. Clearly, any type of graphical image recognizable by a user may be utilized.

As an example, when an application (e.g., commerce application 304) is enrolled by the user, secure processor 102 may create security indicator 240 (street/car/tree) by randomly selecting and combining the street, car, and tree image elements, as previously described. The security indicator 240 may then be displayed to the user on the display device 113 as the security indicator that the user can use in the future to verify whether the application is trusted. Further, the security indicator 240 may be stored in secure memory 137. It should be appreciated that this may be done automatically (created, displayed, and stored), without user input. On the other hand, user interaction may be utilized during enrollment in which the user becomes acquainted with the security indicator 240. In particular, in some embodiments, during enrollment, the user may be given options to help create, change, or modify the security indicator image 240 and the user may then acknowledge and activate the security indicator 240.

In this example, security indicator 240 (street/car/tree) may thereafter be used by the user as an indication that the commerce application 304 when opened to purchase an item from a commerce service provider 160 is a trusted application operating in a trusted execution environment. This is beneficial for such applications as a commerce application 304 in which money is utilized to purchase items. It should be appreciated that the user enrollment and selection of the application and the display of the security indicator 240 for verification may occur in the secure display environment and/or with secure input functionality, as previously described. In particular, the user can use the security indicator 240 to ensure that the particular application (e.g., the commerce application) is a particular trusted application operating in a trusted execution environment (e.g., is not a hacker malware application including other compromised trusted applications). On the other hand, if the security indicator 240 is not the security indicator created for the commerce application 304 upon enrollment (street/car/tree), then the user is notified by the incorrect security indicator that it is not a trusted application operating in a trusted execution environment and may be compromised and the user is notified to not trust the application.

As previously described, the methodology may be composed of N layers of graphics where each layer is a graphical strip of images, containing M unique elements. It should be noted that the M elements need not be graphically discrete. Further, different cropping of a graphics element could yield different images, increasing the number of permutations. Moreover, as previously described, to create a unique digital security indicator 240, the methodology may select a random element from every layer, and then composes them into a single security indicator image 240. The number of possible indicators is a function of the number of layers and elements: MN.

It should be appreciated that the previous example of: layer 1-streets; layer 2-cars; layer 3—trees; from which individuals elements are randomly selected to create the security indicator 240 (street/car/tree)—is just one of an almost infinite amount of examples. It should be appreciated that any type of graphical image element, e.g., faces, stars, trees, streets, automobiles, airplanes, furniture, flowers, utensils, text, symbols (i.e., any type of graphical image) having different types of structural features, shapes, colors, orientation, etc., may be utilized. Clearly, any type of graphical image recognizable by a user may be utilized. Security indicators having different symbols with different colors and shapes are very easy for users to remember and are an effective way of providing an image to a user to indicate to a user that an application is trusted and operating in a trusted execution environment (or not).

Further, this methodology can be used for any type of application that a user wants a verification indicating that the application is a trusted application operating in a trusted execution environment. A previous example has been given as to a financial application 302. In this instance, such as a bank transaction with an on-line bank service provider 160 through a network 150, a user wants to ensure that the financial application is trusted and operating in a trusted execution environment. Thus, as previously described, when the financial application 302 is enrolled, the previously described process may create a security indicator for the user (e.g., security indicator 240 with a red-colored star) such that when the user subsequently runs the financial application 302 the user can view the security indicator 240 to ensure that it is the same and have a reasonable amount of assurance that the transaction with an on-line bank service provider 160 (e.g., a transfer of money from checking to savings) is occurring in a trusted environment and not by a hacked malware application.

Another previous example has been given as to a commerce application 304. In this instance, such as a purchase transaction with an on-line store service provider 160 through a network 150, a user wants to ensure that the commerce application is trusted and operating in a trusted execution environment. Thus, as previously described, when the commerce application 304 is enrolled, the previously described process may create a security indicator for the user (e.g., security indicator 240 with street/car/tree), such that when the user subsequently runs the commerce application 304, the user can view the security indicator 240 to ensure that it is the same and have a reasonable amount of assurance that the transaction with an on-line store service provider 160 (e.g., to purchase an item) is occurring in a trusted environment and not by a hacked malware application. Again, it should be appreciated that the user enrollment and selection of applications and the display of the security indicator 240 for verification may occur in the secure display environment and/or with secure input functionality, as previously described.

It should be appreciated that this methodology may apply to the other previously described types of applications such as: a medical application 306, a government application 308, a corporate application 310, a networking application 312, etc. In essence, this methodology can be applied to any type of application in which a security indicator 240 is generated, as previously described, to assure the user that this is a trusted application operating in a trusted executing environment and is not being interfered with by an attacker/hacker/malware. It should further be appreciated that, as previously described, the security indicator 240 may be randomly generated upon enrollment of an application for each individual application. However, security indicators may also be generated that correspond to a plurality of different applications or for all applications. Further, in some embodiments, a security indicator may be utilized for the operating system, as well. Additionally, it should be appreciated that the security indicator may be utilized alone, or in conjunction with, other types of user inputted passwords, user inputted sensor inputs (e.g., fingerprints, voice, touch inputs), as well as other types of background sensor inputs (e.g. contextual inputs, location, speed, motion, etc.).

Thus, the previously described features provide a method to produce a visual security indicator 240 to satisfy unique security requirements, as well as, aesthetics. The visual security indicator 240 is not predictable such that an attacker may not easily guess it. Further, the two or more randomly generated images from the different layers of graphics that are selected are visually different such that the composed image for the visual security indicator 240 is unique and aesthetic.

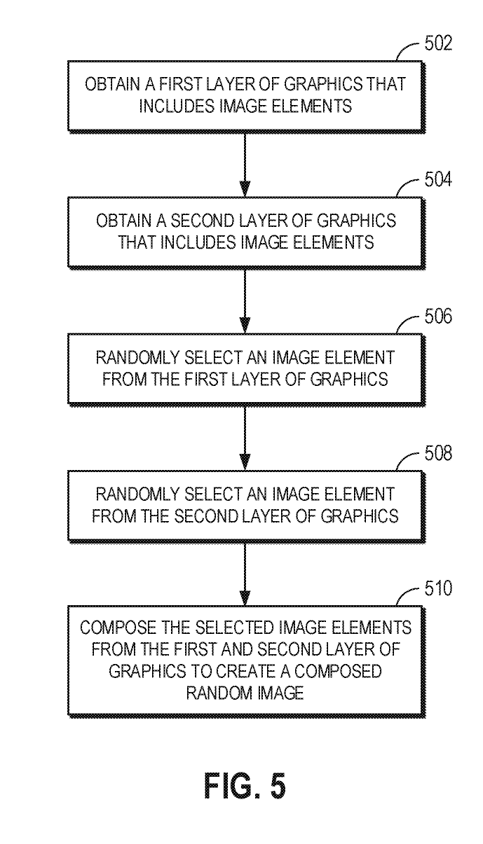

With brief additional reference to FIG. 5, one embodiment may be related to a method to generate a composed random image for a security indicator. At block 502, a first layer of graphics is obtained that includes image elements. Next, at block 504, a second layer of graphics is obtained that includes image elements. Further, at block 506, an image element from the first layer of graphics is randomly selected. Next, at block 508, an image element from the second layer of graphics is randomly selected. At block 510, the selected image elements from the first and second layer of graphics are composed to create the composed random image that may be utilized as a security indicator. The composed random image may be used a security indicator by a user and stored in secure memory.

It should be appreciated that aspects of the previously described processes may be implemented in conjunction with the execution of instructions by a processor (e.g., processor 102) of devices (e.g., computing device 100), as previously described. Particularly, circuitry of the devices, including but not limited to processors, may operate under the control of a program, routine, or the execution of instructions to execute methods or processes in accordance with embodiments described (e.g., the processes and functions of FIGS. 2-5). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a secure processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing device comprising:
a processor operable in a secure mode configured to:
obtain a first layer of graphics that includes image elements;
obtain a second layer of graphics that includes image elements;
randomly select an image element from the first layer of graphics;
randomly select an image element from the second layer of graphics; and
compose the selected image elements from the first and second layer of graphics to create a composed random image; and
a memory to store the composed random image.

2. The computing device of claim 1, further comprising a display device, wherein the processor is configured to command the display device to display the composed random image as a security indicator to a user on the computing device when an application is selected by the user in a secure display environment.

3. The computing device of claim 2, wherein, when an application is enrolled by the user, the processor is configured to:
create the composed random image;
store the composed random image; and
command the display of the composed random image as the security indicator on the display device.

4. The computing device of claim 3, wherein the application enrolled is at least one a financial application or a commerce application.

5. The computing device of claim 3, wherein the application enrolled is an operating system.

6. The computing device of claim 1, wherein the first layer of graphics is randomly selected by the processor from a group of image elements and the second layer of graphics is randomly selected by the processor from the group of image elements.

7. The computing device of claim 6, wherein each image element of each layer of graphics selected by the processor includes at least one of a differing structural feature, shape, color, or orientation.

8. The computing device of claim 6, wherein any number of two or more layers of graphics are selectable by the processor from the group of image elements to create the composed random image.

9. A method comprising:
obtaining a first layer of graphics that includes image elements;
obtaining a second layer of graphics that includes image elements;
randomly selecting an image element from the first layer of graphics;
randomly selecting an image element from the second layer of graphics; and
composing the selected image elements from the first and second layer of graphics to create a composed random image; and
storing the composed random image in a memory.

10. The method of claim 9, further comprising commanding a display device to display the composed random image as a security indicator to a user when an application is selected by the user in a secure display environment.

11. The method of claim 10, wherein, when an application is enrolled by the user, further comprising:
creating the composed random image;
storing the composed random image; and
commanding the display of the composed random image as the security indicator on the display device.

12. The method of claim 11, wherein the application enrolled is at least one a financial application or a commerce application.

13. The method of claim 11, wherein the application enrolled is an operating system.

14. The method of claim 9, wherein the first layer of graphics is randomly selected from a group of image elements and the second layer of graphics is randomly selected from the group of image elements.

15. The method of claim 14, wherein each image element of each layer of graphics selected includes at least one of a differing structural feature, shape, color, or orientation.

16. The method of claim 14, wherein any number of two or more layers of graphics are selectable from the group of image elements to create the composed random image.

17. A non-transitory computer-readable medium including code that, when executed by a processor operating in a secure mode of a computing device, causes the processor to:
obtain a first layer of graphics that includes image elements;
obtain a second layer of graphics that includes image elements;
randomly select an image element from the first layer of graphics;
randomly select an image element from the second layer of graphics; and
compose the selected image elements from the first and second layer of graphics to create a composed random image; and
store the composed random image in a memory.

18. The computer-readable medium of claim 17, further comprising code to command a display device to display the composed random image as a security indicator to a user when an application on the computing device is selected by the user in a secure display environment.

19. The computer-readable medium of 18, wherein, when an application is enrolled by the user, further comprising code to:
create the composed random image;
store the composed random image; and
command the display of the composed random image as the security indicator on the display device.

20. The computer-readable medium of claim 19, wherein the application enrolled is at least one a financial application or a commerce application.

21. The computer-readable medium of claim 19, wherein the application enrolled is an operating system.

22. The computer-readable medium of claim 17, wherein the first layer of graphics is randomly selected from a group of image elements and the second layer of graphics is randomly selected from the group of image elements.

23. The computer-readable medium of claim 22, wherein each image element of each layer of graphics selected includes at least one of a differing structural feature, shape, color, or orientation.

24. The computer-readable medium of claim 22, wherein any number of two or more layers of graphics are selectable from the group of image elements to create the composed random image.

25. A computing device comprising:
means for obtaining a first layer of graphics that includes image elements;
means for obtaining a second layer of graphics that includes image elements;
means for randomly selecting an image element from the first layer of graphics;
means for randomly selecting an image element from the second layer of graphics;
mean for composing the selected image elements from the first and second layer of graphics to create a composed random image; and
means for storing the composed random image in a memory.

26. The computing device of claim 25, further comprising means for displaying the composed random image as a security indicator to a user when an application on the computing device is selected by the user in a secure display environment.

27. The computing device of claim 26, wherein, when an application is enrolled by the user, further comprising:
means for creating the composed random image;
means for storing the composed random image; and
means for commanding the display of the composed random image as the security indicator.

28. The computing device of claim 27, wherein the application enrolled is at least one a financial application or a commerce application.

29. The computing device of claim 27, wherein the application enrolled is an operating system.

30. The computing device of claim 25, wherein the first layer of graphics is randomly selected from a group of image elements and the second layer of graphics is randomly selected from the group of image elements.
